(19) United States
(12) Patent Application Publication
(10) Pub. No.: US 2025/0073928 A1
(43) Pub. Date: Mar. 6, 2025

(54) GRIPPING DEVICE AND ROBOT HAVING THE SAME

(71) Applicants: SHANGHAI FLEXIV ROBOTICS TECHNOLOGY CO., LTD., Shanghai (CN); FLEXIV LTD., Grand Cayman, Cayman Islands (GB)

(72) Inventors: Chi-Tao KUAN, Santa Clara, CA (US); Hao JIANG, Santa Clara, CA (US)

(21) Appl. No.: 18/260,530

(22) PCT Filed: Apr. 7, 2023
(86) PCT No.: PCT/CN2023/086815

§ 371 Date: Jul. 6, 2023

(51) Int. Cl. B25J 15/08

(52) U.S. Cl. CPC B25J 15/08

(57) ABSTRACT

A gripping device for a robot includes a base and at least two gripper assemblies. Each gripper assembly includes a gripping finger and a first link assembly. In a first gripping mode, the gripping fingers are in a first state, and the first link assemblies are configured to drive the gripping fingers to move inward and contact a target object. In a second gripping mode, the gripping fingers are in the first state, and the first link assemblies are configured to drive the gripping fingers to move outward and contact the target object. In a third gripping mode, the first link assemblies are configured to drive the gripping fingers switch to the second state from the first state, and drive the gripping fingers to move inward and contact the target object in cooperation with the first link assemblies.

### TECHNICAL FIELD

The present disclosure relates to the robotic technology, and in particular, to a gripping device and a robot having the same.

### BACKGROUND

Robots with gripping devices are widely used in many fields such as industrial manufacturing logistics and transportation, etc. With the continuous development of the technology, the application scenarios of the robots are becoming more diverse. However, the gripping devices of the current robots are limited to a single gripping mode. Different gripping devices are needed to be designed for different tasks. For example, in the industrial manufacturing field, since most of the target objects to be gripped are relatively regular in shape, the gripping device usually implements the griping operation by parallel movements of the gripping finger. However, such a gripping device cannot grip large objects due to the limitation of the gripping finger stroke. In addition, the rigid structure of the gripping finger may damage target objects that are large, or easily deformed or fragile. Therefore, a different gripping device is required for the larger, or easily deformable or fragile target objects.

### SUMMARY

In one aspect, the present disclosure provides a gripping device configured to grip a target object. The gripping device includes a base and at least two gripper assemblies. Each of the gripper assemblies includes a gripping finger and a first link assembly. The gripping finger is configured to grip the target object. The gripping finger has a first state and a second state. An angle of a gripping surface of each gripping finger is kept unchanged in the first state, and each of the gripping fingers is moved close to each other in a first direction in the second state in comparison with the first state. One end of the first link assembly is rotatably connected to the base, and the other end of the first link assembly is rotatably connected to the gripping finger. The gripping device has a first gripping mode, a second gripping mode and a third gripping mode. In the first gripping mode, the gripping fingers are in the first state, and the first link assemblies are configured to drive the gripping fingers to move inward and contact the target object. In the second gripping mode, the gripping fingers are in the first state, and the first link assemblies are configured to drive the gripping fingers to move outward and contact the target object. In the third gripping mode, the first link assemblies are configured to drive the gripping fingers switch to the second state from the first state, and drive the gripping fingers to move inward and contact the target object in cooperation with the first link assemblies.

In some embodiments, each of the gripper assemblies further includes an adhesion assembly. The adhesion assembly is arranged on an inner side of the corresponding gripping finger, and/or the adhesion assembly is arranged on an inner side of the corresponding first link assembly. Each gripping finger further has a third state in which the gripping fingers are moved away from each other in a second direction in comparison with the first state. The gripping device further has a fourth gripping mode in which the gripping fingers are in the third state and the first link assemblies are configured to drive the gripping fingers to move inward to enable the adhesion assemblies to contact the target object.

In some embodiments, each of the gripper assemblies further includes a gripping finger positioning assembly and an orientation control assembly. The orientation control assembly is connected to a first end of the gripping finger positioning assembly, and configured to control a posture of the corresponding gripping finger by controlling a posture of the gripping finger position assembly. For each gripper assembly, in the first gripping mode and the second gripping mode, the orientation control assembly is configured to control the other end of the gripping finger positioning assembly to contact the gripping finger to maintain the gripping finger in the first state.

In some embodiments, each of the gripper assemblies further includes a tension providing component, and the tension providing component is configured to provide a tension force for the corresponding first link assembly, such that the corresponding gripping finger has a tendency to move towards the second direction under the tension force. For each gripper assembly, in the first gripping mode and the second gripping mode, the gripping finger positioning assembly is configured to provide a support force to the gripping finger to prevent the gripping finger from being moved towards the second direction, thereby maintaining the gripping finger in the first state.

In some embodiments, each gripping finger includes a first portion and a second portion connected perpendicularly. Each first link assembly includes a plurality of links. The plurality of links cooperate with the first portion of the gripping finger to constitute a quadrilateral link structure, and the quadrilateral link structure is configured to rotate when driven by a drive device, thereby moving the gripping finger and adjusting the state of the gripping finger.

In some embodiments, each first link assembly includes a first link, a second link, and the third link. A first end of the first link is rotatably connected to the base, and a second end of the first link is rotatably connected to a first end of the second link. The tension providing component is arranged between the first link and the second link to provide a torque force to the first link and the second link, such that the second link has a tendency to deflect with respect to the first link in the second direction and pulls the corresponding gripping finger, and the corresponding gripping finger has a tendency to move towards the second direction. A second end of the second link is rotatably connected to one end of the first portion of the corresponding gripping finger, and the other end of the first portion of the corresponding gripping finger is rotatably connected to a first end of the third link, and a second end of the third link is rotatably connected to the base. In the third gripping mode, each gripping finger grips the target object in cooperation with the corresponding third link.

In some embodiments, each gripping finger positioning assembly includes at least one link, and the at least one link forms a support structure that provides the support force to the corresponding gripping finger in the first gripping mode and the second gripping mode.

In some embodiments, each gripping finger positioning assembly includes a fourth link, a fifth link, and a sixth link. The fourth link, the fifth link, the sixth link and the corresponding third link are rotatably connected in sequence to jointly constitute a parallelogram link assembly, and the fourth link is always parallel to the sixth link. The parallelogram link assembly is configured to provide the support force in the first gripping mode and the second gripping mode by the sixth link contacting the first portion of the gripping finger in parallel.

In some embodiments, in the fourth gripping mode, the orientation control assembly is configured to control the fourth link to rotate in the second direction such that the gripping finger is moved to the third state in the second direction under the tension force provided by the tension providing component.

In some embodiments, each orientation control assembly includes a cam in contact with the corresponding fourth link. For each gripper assembly, the cam is configured to, in a first position, maintain the fourth link and the sixth link in an initial state, such that the gripping finger is maintained in the first state under the tension force provided by the tension providing component and the support force provided by the sixth link. The cam is further configured to, in a second position, enable the fourth link and the sixth link to be deflected in the second direction, such that the gripping finger is moved towards the second direction under the tension force provided by the tension providing component, and the gripping finger is switched to the third state.

In some embodiments, the adhesion assembly is made of gecko adhesive material.

In another aspect, the present disclosure provides a robot, the robot includes the gripping device as described in any of the aforementioned embodiments.

Details of one or more embodiments of the present disclosure are presented in the following accompanying drawings and description. Other features, objects, and advantages of the present disclosure will become apparent from the specification, the accompanying drawings, and the claims.

### BRIEF DESCRIPTION OF THE DRAWINGS

In order to illustrate the technical solutions in the embodiments of the present disclosure or the related technology more clearly, the accompanying drawings used in the description of the embodiments or the related technology will be briefly introduced below. Apparently, the accompanying drawings in the following description are only some embodiments of the present disclosure. For those of ordinary skill in the art, other drawings can also be derived from these drawings without creative effort.

FIG. 1 is a schematic diagram of a gripping device according to an embodiment of the preset disclosure.

FIG. 2 is a schematic diagram of a gripping device in a first gripping mode according to an embodiment of the preset disclosure.

FIG. 3 is a schematic diagram of a gripping device in a second gripping mode according to an embodiment of the preset disclosure.

FIG. 4 is a schematic diagram of a gripping device in a third gripping mode according to an embodiment of the preset disclosure.

FIG. 5 is a schematic diagram of a gripping device in a fourth gripping mode according to an embodiment of the preset disclosure.

FIG. 6 is a schematic diagram of a robot according to an embodiment of the preset disclosure.

### DETAILED DESCRIPTION OF THE EMBODIMENTS

The technical solutions in the embodiments of the present disclosure will be described clearly and completely below with reference to the accompanying drawings in the embodiments of the present disclosure. Obviously, the described embodiments are only a part of the embodiments of the present disclosure, but not all of the embodiments. Other embodiments obtained based on the embodiments in the present disclosure without creative labor by a person of ordinary skill in the art fall within the protection scope of the present disclosure.

Unless otherwise defined, all technical and scientific terms used herein have the same meaning as commonly understood by one of ordinary skill in the art to which this disclosure belongs. The terms herein are only used to illustrate the specific embodiments, but are not intended to limit the disclosure. The terms “include”, “have” and any variations in the specification, the claims, and the description of the drawings of the present disclosure are intended to cover non-exclusive inclusion.

In the description of the embodiments of the present disclosure, the terms “first”, “second”, etc. are used only to distinguish different objects, but cannot be construed as indicating or implying the relative importance or implicitly indicating the number, the particular order or the priority of the indicated technical features. In the description of the embodiments of the present disclosure, the term “plurality” means more than two (including two), unless otherwise specifically limited.

The description of the term “embodiment” is intended to refer to a specific feature, a configuration, a material, or a characteristic described included in at least one embodiment of the present disclosure. The phrase that appears at various positions in the specification does not necessarily refer to the same embodiment, nor is it a separate or an alternative embodiment mutually exclusive with other embodiments. It should be understood, both explicitly and implicitly, by those of skill in the art that the embodiments described herein may be combined with other embodiments.

In the description of the embodiments of the present disclosure, the term “and/or” is only a description of an association relationship of the association objects, which indicates that there can be three relationships. For example, A and/or B may indicate the following three cases: a single existence of A, an existence of both A and B. and a single existence of B. In addition, the character “/” in the description generally indicates that the context object is an “or” relationship.

In the description of the embodiments of the present disclosure, unless otherwise defined, the technical terms “mounted”, “connected”, “fixed”, etc., should be understood in a broad sense, e.g., it may be a fixed connection, a removable connection, or integrated. It may also be a mechanical connection or an electrical connection. It may also be a direct connection or an indirect connection through an intermediate medium. It may also be an internal connection of two components or an interaction between two components. To those of ordinary skill in the art, the specific meaning of the above terms in the embodiments of the present disclosure can be understood according to specific conditions.

At present, robots with gripping devices are widely used in various fields such as industrial manufacturing, logistics and transportation, etc. For example, in the industrial manufacturing field, robotic grippers are used to grip and install components. In the logistics field, robotic grippers are used to grip and move items. However, the applicant has noted that there is a single gripping mode of the current robots, which cannot be adapted to multiple scenarios. For example, the robotic grippers in the industrial manufacturing grip the components through mechanical fingers like human fingers, which can realize a high accuracy and reliability. However, in such a gripping mode, large objects may not be gripped due to a limitation of a travel range of the mechanical fingers. In addition, deformable or fragile objects may be damaged due to a large clamping force of the mechanical fingers. Therefore, additional robots of different types may be required for such large objects, or deformable or fragile objects, which increases the complexity and the cost of automated industrial manufacturing.

The applicant has designed a gripping device that can be switched between different gripping modes and can be used in robotics. The gripping device includes a base and at least two gripper assemblies. Each of the gripper assemblies includes a gripping finger and a first link assembly. Each gripping finger has a first state and a second state. In the first state, an angle of a gripping surface of each gripping finger is kept unchanged. In the second state, the gripping fingers are moved close to each other in a first direction in comparison with the first state. One end of the first link assembly is rotatably connected to the base, and the other end of the first link assembly is rotatably connected to the gripping finger. The gripping device has a first gripping mode, a second gripping mode and a third gripping mode. In the first gripping mode, the gripping fingers are in the first state, and the first link assemblies are configured to drive the gripping fingers to move inward and contact the target object. In the second gripping mode, the gripping fingers are in the first state, and the first link assemblies are configured to drive the gripping fingers to move outward and contact the target object. In the third gripping mode, the first link assemblies are configured to drive the gripping fingers switch to the second state from the first state, and drive the gripping fingers to move inward and contact the target object in cooperation with the first link assemblies.

The concept of the present disclosure will be described in detail below with reference to the embodiments. The gripping device disclosed in each embodiment of the present disclosure can be applied to, but is not limited to, robotic arms or robots in the fields of industrial manufacturing, logistics and transportation, etc. The gripper assemblies of the gripping device are driven by a drive device and cooperate with each other to implement the gripping operation. In this disclosure, there is no limitation to the driving method for the gripper assemblies, as long as the gripper assemblies can implement an opening operation and a closing operation, and cooperate with each other to implement the gripping operation. For example, each gripper can be driven by multiple linked links to implement the opening operation and the closing operation, or driven by means of tendons to implement the opening operation and the closing operation. Tendon driving is existing technology and will not be described in detail herein.

The present disclosure will be described below with reference to exemplary embodiments of the gripping device in which the gripper assemblies are driven to be opened or closed by multiple linked links to achieve gripping.

In the embodiments of the present disclosure, the direction in which the gripping fingers 21 are close to each other is referred to as a first direction, and the direction in which the gripping fingers 21 are away from each other is referred to as a second direction.

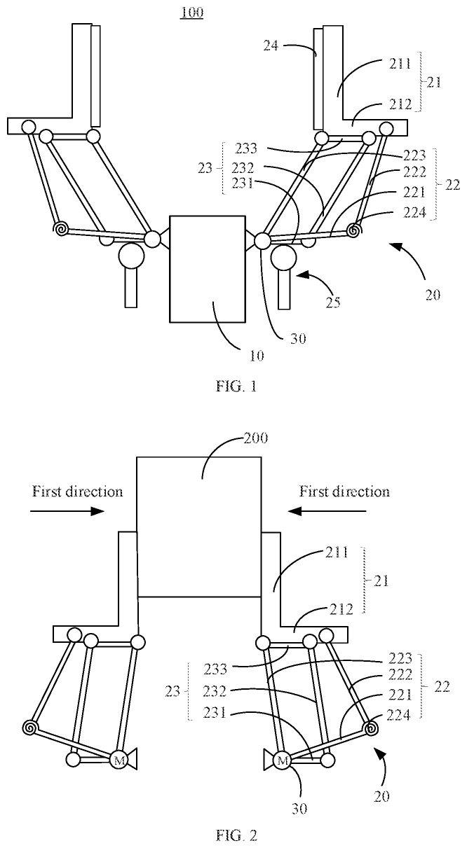

FIG. 1 is a schematic diagram showing a gripping device 100 according to some embodiments of the present disclosure. The gripping device 100 includes a base 10, at least two gripper assemblies 20, and a drive device 30. The at least two gripper assemblies 20 are configured to cooperate with each other to grip a target object under the drive of the drive device 30. Each gripper assembly 20 includes a gripping finger 21 and a first link assembly 22. The gripping finger 21 is configured to grip the target object. Each gripping finger 21 has a first state and a second state. In the first state, an angle of a gripping surface of each gripping finger 21 is kept unchanged. In the second state, the gripping fingers 21 are moved close to each other in the first direction in comparison with the first state. One end of the first link assembly 22 is rotatably connected to the base 10, and the other end of the first link assembly 22 is rotatably connected to the gripping finger 21. The gripping device 100 has a first gripping mode, a second gripping mode, and a third gripping mode. In the first gripping mode, the gripping fingers 21 are in the first state, and the first link assemblies 22 are configured to drive the gripping fingers 21 to move inward (i.e., move in the first direction) and contact the target object. In the first gripping mode, the gripping device 100 can apply a gripping force to the target object in the first direction by each gripping finger 21, thereby achieving the gripping operation. In the second gripping mode, the gripping fingers 21 are in the first state, and the first link assemblies 22 drive the gripping fingers 21 to move outward (i.e., move in the second direction) and contact the target object. In the second gripping mode, the gripping device 100 can apply a dilating force in the second direction to the target object by each gripping finger 21, thereby achieving the gripping operation. In the third gripping mode, the first link assemblies 22 are configured to drive the gripping fingers 21 switch to the second state from the first state, and drive the gripping fingers 21 to move inward and contact the target object in cooperation with the first link assemblies 22. In the third gripping mode, the gripping device 100 can grip the target object by means of the gripping fingers 21 in cooperation with the first link assemblies 22.

It should be noted that in some embodiments of the present disclosure, the quantity of the gripper assemblies 20 can be set according to actual needs. The structures of the gripper assemblies 20 may be the same, and the structure of one of the gripper assemblies will be described below as an example.

In an embodiment, as shown in FIG. 1, each gripper assembly 20 includes the gripping finger 21 and the first link assembly 22. The gripping finger 21 includes a first portion 211 and a second portion 212 that are perpendicularly connected, and a vertical cross section of the gripping finger 21 is substantially L-shaped.

The first link assembly 22 includes a plurality of links. The plurality of links cooperate with the first portion 211 of the gripping finger 21 to form a quadrilateral link structure. The quadrilateral link structure is configured to rotate when driven by the drive device, thereby moving the gripping finger 21 and adjusting the state of the gripping finger.

In this embodiment, the first link assembly 22 includes a first link 221, a second link 222, and a third link 223. A first end of the first link 221 is rotatably connected to the base 10, and a second end of the first link 221 is rotatably connected to a first end of the second link 222. A second end of the second link 222 is rotatably connected to an end of the first portion 211 of the gripping finger 21 away from the second portion 212. A first end of the third link 223 is rotatably connected to an end of the first portion 211 of the gripping finger 21 close to the second portion 212. A second end of the third link 223 is rotatably connected to the base 10. The first link 221, the second link 222, the first portion 211 of the gripping finger 21, and the third link 223 form the quadrilateral link structure cooperatively. The first link 221 is configured to rotate when driven by the drive device 30 which in turn drives the quadrilateral link structure to rotate, causing the gripping finger 21 to translate and deflect under the drive of the first link assembly 22, thereby realizing the various gripping modes of the gripping device 100. The specific operation manner of the first link assembly 22 will be described in detail in the following embodiments.

In some other embodiments, the first link assembly 22 may include four links. For example, in addition to the first link 221, the second link 222 and the third link 223, the first link assembly 22 may also include a fixed link (not shown) that is parallel to and fixedly connected to the first portion 211 of the gripping finger 21. The first link 221, the second link 222, the fixed link and the third link223 are connected in sequence to constitute the quadrilateral link structure.

In some embodiments, the gripper assembly 20 further includes a gripping finger positioning assembly 23 and an orientation control assembly 25. One end of the gripping finger positioning assembly 23 is connected to the orientation control assembly 25, and the other end of the gripping finger positioning assembly 23 is in contact with the gripping finger 21. The orientation control assembly 25 is configured to control the posture of the gripping finger 21 by controlling the posture of the gripping finger positioning assembly 23. In the first gripping mode and the second gripping mode, the gripping finger positioning assembly 23 is configured to maintain the gripping finger 21 in the first state under the control of the orientation control assembly 25.

For example, in an embodiment, the gripping finger positioning assembly may be a rotatable locking element. One end of the locking element is connected to the orientation control assembly, and the locking element can be rotated under the control of the orientation control assembly. In the first gripping mode and the second gripping mode, the orientation control assembly controls the locking element to rotate until the other end of the locking element is in contact with the first portion of the gripping finger, thus the locking element locks the gripping finger in the first state. In the other gripping modes, the orientation control assembly controls the other end of the locking element away from the gripping finger, such that the state of the gripping finger can be adjusted under the drive of the first link assembly.

For another example, as shown in FIG. 1, in an embodiment, the first link assembly 22 further includes a tension providing component 224 configured to provide a tension force for the first link assembly 22, such that the gripping finger 21 has a tendency to move towards the second direction under the tension force. In the first gripping mode and the second gripping mode, the gripping finger positioning assembly 23 is configured to provide a support force to the gripping finger 21 to prevent the gripping finger 21 from being moved towards the second direction, thereby maintaining the gripping finger 21 in the first state in cooperation with the tension providing component 224.

In an embodiment, the tension providing component 224 is arranged between the first link 221 and the second link 222 to provide the torque force to the first link 221 and the second link 222, such that the second link 222 has a tendency to deflect with respect to the first link 221 in the second direction. Meanwhile, the second link 222 will pull the gripping finger 21 towards the second direction, such that the gripping finger 21 also has a tendency to move towards the second direction.

In this embodiment, the tension providing component 224 may cause the second link 222 to have the tendency to deflect with respect to the first link 221 in the second direction by a pre-loaded elastic force. For example, in some embodiments, the tension providing component 224 may be a torsion spring. A pre-loaded elastic force of the torsion spring causes the second link 222 to have the tendency to deflect with respect to the first link 221 in the second direction. For another example, in some other embodiments, the tension providing component 224 may be a tension spring. One end of the tension spring is connected to the second end of the second link 222, and the other end of the tension spring is connected to the base 10. A tension force of the tension spring causes the second link 222 to have the tendency to deflect with respect to the first link 221 in the second direction.

In this embodiment, the gripping finger positioning assembly may include at least one link, and the at least one link forms a support structure that provides the support force to the gripping finger 21 in the first gripping mode and the second gripping mode.

For example, as shown in FIG. 1, the gripping finger positioning assembly 23 may include a fourth link 231, a fifth link 232, and a sixth link 233 that are rotatably connected in sequence. A first end of the fourth link 231 is rotatably connected to the second end of the third link 223 connected to the base 10, and a second end of the fourth link 231 is rotatably connected to a first end of the fifth link 232. A second end of the fifth link 232 is rotatably connected to a first end of the sixth link233, and a second end of the sixth link 233 is rotatably connected to the first end of the third link 223 connected to the gripping finger21. The fourth link 231, the fifth link 232, the sixth link 233 and the third link 223 constitute a parallelogram link assembly. In the parallelogram link assembly, the fourth link 231 is always parallel to the sixth link 233, and the sixth link 233 is in contact with the gripping finger 21. Therefore, the posture of the gripping finger 21 can be controlled by controlling the posture of the fourth link 231. In the first gripping mode and the second gripping mode, i.e., the gripping finger 21 is in the first state, the fourth link 231 and the sixth link 233 of the gripping finger positioning assembly 23 are always kept in the parallel direction. The sixth link 233 is in contact with the first portion 211 of the gripping finger 21 in parallel and provides the support force to the gripping finger 21, so as to prevent the gripping finger 21 from being moved towards the second direction. Therefore, in the case that there is no external drive force or the external drive force is no more than the tension force provided by the tension providing component 224, the gripping finger 21 is maintained in the first state under the tension force provided by the tension providing component 224 and the support force provided by the sixth link 233. The operation mode of the gripping finger positioning assembly 23 and the tension providing component 224 will be described in detail in the following embodiments.

It should be understood that the elastic force of the torsion spring or the tension spring may be set and adjusted according to actual conditions, such that the elastic force generated by the torsion spring or the tension spring is large enough to cause the second link 222 to have the tendency to move towards the second direction with respect to the first link 221 in the first gripping mode and the second gripping mode, and the drive device 30 can drive the second link 222 to overcome the elastic force of the torsion spring or the tension spring without damage in other gripping modes of the gripping device.

In other embodiments, the rotation and restriction between the links of the first link assembly 22 and the rotation and restriction between the links, the base 10 and the gripping fingers 21 may be achieved by means of a drive motor, a gear, or the like provided at connection positions, without the tension providing component 224 and the gripping finger positioning assembly 23. These solutions are all within the principles and spirit of the present disclosure.

In an embodiment of the present disclosure, the gripping device 100 may further has a fourth gripping mode in addition to the three aforementioned gripping modes. For the fourth gripping mode, each gripper assembly 20 may further includes an adhesion assembly 24 for gripping the target object by means of adhesion and/or adsorption. In this embodiment, the adhesion assembly 24 is arranged on an inner side of the gripping finger 21, i.e., the side of the second portion 212 of the gripping finger 21 towards the first direction. Each gripping finger 21 further has a third state in which the gripping fingers 21 are moved away from each other in the second direction in comparison with the first state. In the fourth gripping mode, the gripping fingers 21 are in the third state, and the first link assemblies 22 are configured to drive the gripping fingers 21 to move inward to enable the adhesion assemblies 24 to contact the target object. The gripping device 100 performs the gripping operation by adhering and/or adsorbing to the target object through the adhesion assemblies 24.

In another embodiment, the adhesion assembly 24 may also be provided on an inner side of each first link assembly 22, for example, on a side of each third link 223 towards the first direction. Alternatively, both the inner side of the gripping finger 21 and the inner side of the first link assembly 22 of each gripper assembly 20 are provided with the adhesion assembly 24. The operation process of the fourth gripping mode will be described in detail in the following embodiments.

In some embodiments, each adhesion assembly 24 may be a layer of gecko adhesive material. The gecko adhesive material was designed by inspiration of the gecko, and has a structure imitating the gecko's foot. The surface of the gecko adhesive material layer is provided with a plurality of micro-wedge structures that can adhere to a surface of an object by intermolecular interactions (e.g., Van der Waals forces). In the fourth gripping mode, the gripping operation is implemented by adhering to the surface of the target object by the gecko adhesive material layer. Since the gecko adhesive material film is a known technology, it will not be described in detail here.

It should be understood that each adhesion assembly 24 in the present disclosure application may also be any other structures or materials capable of gripping and releasing the target object by means of adsorption or adhesion. The structure and material of the adhesion assembly 24 is not limited in the present disclosure, any solution that can grip objects by means of adsorption or adhesion is within the protection scope of the present application. For example, the adhesion assembly 24 may also be one or more vacuum adsorption devices, such as suction cups, provided on the gripping finger and/or the third link.

In this embodiment, in the fourth gripping mode, since the gripping finger 21 needs to move towards the second direction, the orientation control assembly 25 is also configured to adjust the posture of the gripping finger positioning assembly 23 in the fourth gripping mode, such that the gripping finger 21 can be moved towards the second direction to the third state under the tension force of the tension providing component 224.

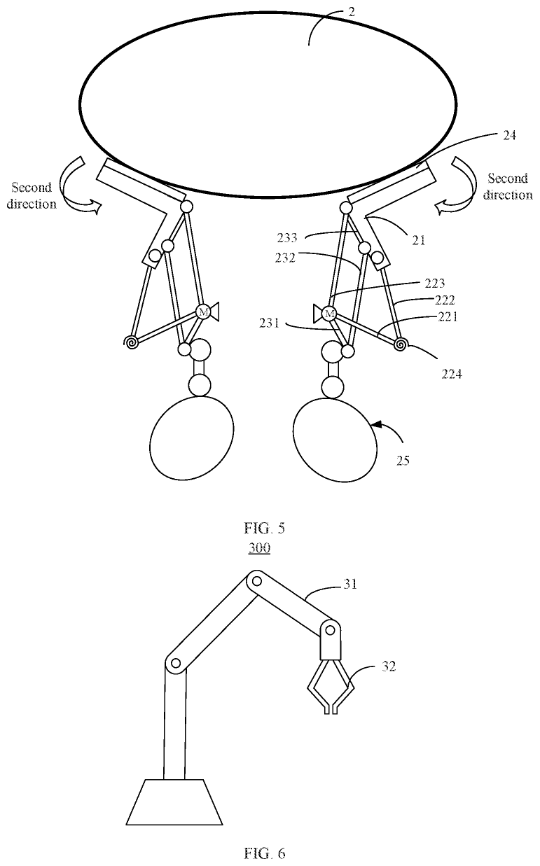

For example, in some embodiments, for each gripper assembly 20, when the gripping finger positioning assembly 23 is the parallelogram link assembly, the orientation control assembly 25 may include a cam. As shown in FIG. 4, the cam is in contact with the fourth link 231 for controlling the position of the parallelogram link assembly through the fourth link 231. In the first gripping mode, the second gripping mode and the third gripping mode. i.e., the gripping finger 21 is in the first state and the second state, the cam is in a first position to maintain the fourth link 231 and the sixth link 233 of the parallelogram link assembly at in initial posture. In the fourth gripping mode, as shown in FIG. 5, the cam is rotated to a second position, enabling the fourth link 231 and the sixth link 233 of the parallelogram link assembly to be deflected in the second direction. Therefore, the gripping finger 21 is moved towards the second direction under the tension force provided by the tension providing component 224, and switched to the third state.

In another embodiment, each orientation control assembly 25 may be a drive unit such as an electric motor that individually drives the fourth link 231. In the first gripping mode and the second gripping mode, the drive unit can directly control the fourth link always parallel to the first portion 211 of the gripping finger. In the third gripping mode, the drive unit can control the fourth link 231 to rotate in the second direction, enabling the gripping finger 21 to be switched to the third state.

It should be understood that the orientation control assembly 25 may also be any other form of drive mechanism, as long as it is able to control the gripping finger positioning assembly 23 to change the restriction of the gripping finger 21. The form of the orientation control assembly is not limited in the present disclosure.

The operation processes of the gripping device 100 in different gripping modes will be described in detail below with reference to FIGS. 2-5.

FIG. 2 is a schematic diagram showing the gripping device 100 in the first gripping mode according to an embodiment of the present disclosure. In the first gripping mode, each gripping finger 21 is in the first state, and the angle of the gripping surface of each gripping finger 21 is kept unchanged. For example, the sixth link 233 of each gripping finger positioning assembly 23 is in contact with the first portion 211 of the corresponding gripping finger 21 in parallel to support the gripping finger 21. The sixth link 233 is maintained in the horizontal posture corresponding to the first state of the gripping finger 21 under the control of the orientation control assembly 25, thus keeping the gripping finger 21 in the first state in cooperation with the tension providing component 224. During the gripping process, each first link 221 is rotated in the first direction when driven by the drive device 30. The first link 221 drives the second link 222 which in turn drives the corresponding gripping finger 21 to move inward (i.e., in the first direction), thus the gripping fingers 21 get close to each other. The gripping fingers 21 contact the target object 200 and apply gripping forces to the target object 200 in the first direction, thereby gripping the target object 200. During the movement of the gripping fingers 21 in the first direction, the third links 223 are also rotated in the first direction, so that the third links 223 drive the parallelogram gripping finger positioning assemblies 23 to deflect in parallel in the first direction. The planes of the sixth links 233 are kept at a constant angle to always keep the gripping fingers 21 in the first state in cooperation with the tension providing components 224.

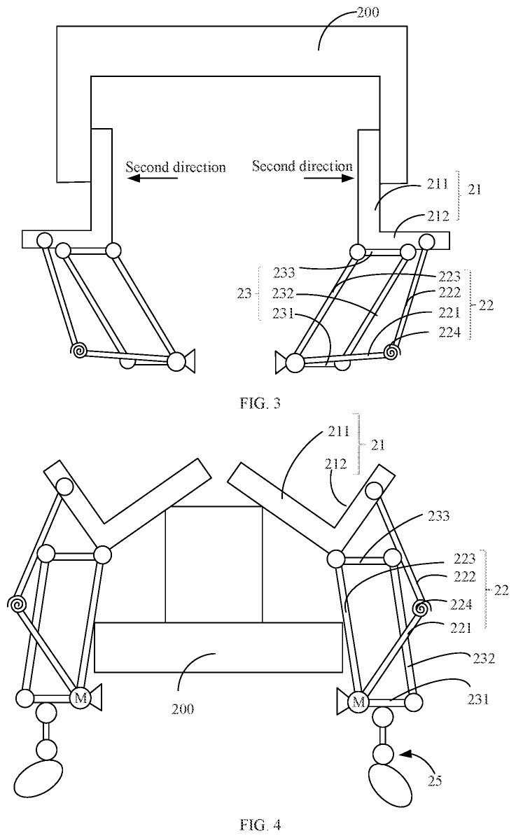

FIG. 3 is a schematic diagram showing the gripping device in the second gripping mode according to an embodiment of the present disclosure. In the second gripping mode, the gripping fingers 21 are in the first state, and each gripping finger 21 is moved outward (i.e., in the second direction), after being inserted into an interior space of the target object 200, to contact the target object, thereby gripping the target object by applying a dilating force in the second direction to two opposite inner walls of the target object 200. It should be understood that the depth of the gripping fingers 21 into the target object 200 can be adjusted according to the actual situation. During the gripping process, the first links 221 are rotated in the second direction when driven by the drive device 30, and the first links 221 drive the second links 222 which in turn drive the gripping fingers 21 to move away from each other. Upon contacting the target object 200, the gripping fingers apply the dilating forces to the target object 200 in the second direction, thereby gripping the target object 200. During the movement of the gripping fingers 21 in the second direction, the third links 223 are also rotated in the second direction, so that the third links drive the parallelogram gripping finger positioning assemblies 23 to deflect in parallel in the second direction. The planes of the sixth links 233 are kept at a constant angle to always keep the gripping fingers 21 in the first state in cooperation with the tension providing component 224.

FIG. 4 is a schematic diagram showing the gripping device in the third grasping mode according to an embodiment of the present disclosure. In the third gripping mode, the gripping device grips the target object by the gripping fingers 21 and the corresponding first link assemblies 22. As shown in FIG. 4, in the third gripping mode, the first links 221 are rotated in the first direction when driven by the drive device 30, thereby driving the third links 223 to rotate in the first direction as well. The target object 200 is located between the first link assemblies 22. When rotating to the position of the target object 200, the third links 223 are blocked by the target object 200 and cannot rotate anymore. However, the drive device 30 drives the first links 221 to continue to rotate in the first direction, so that the second links 222 and the first links 221 break the restriction of the tension providing components 224, and the second links 222 drive the gripping fingers 21 to continue to rotate in the first direction. The first portions 211 of the gripping fingers 21 are separated from the sixth links 233, and the gripping fingers 21 are moved towards the first direction in comparison with the first state. Consequently, the gripping fingers 21 are switched to the second state where each of the gripping fingers 21 cooperates with the corresponding third link 223 to grip the target object 200.

FIG. 5 is a schematic diagram showing a gripping device in the fourth gripping mode according to an embodiment of the present disclosure. In the fourth gripping mode, the gripping fingers 21 are switched to the third state, and the gripper assemblies 20 grip the target object 200 by means of the adhesion assemblies 24 arranged on the gripping fingers 21 and/or the first link assemblies 22. The operation process of the fourth gripping mode will be described in detail below with reference to FIG. 5. In an embodiment, the orientation control assemblies 25 first adjust the posture of the gripping finger positioning assemblies 23, such that the gripping finger positioning assemblies 23 cooperate with the tension providing components 224 to adjust the gripping fingers 21 to the third state. For example, for each gripper assembly 20, in the case that the orientation control assembly 25 includes the cam, the cam is rotated from a first position to a second position, enabling the fourth link 231 and the sixth link 233 in the corresponding gripping finger positioning assembly 23 to rotate in the second direction. The tension force provided by the tension providing component 224 causes the gripping finger 21 to be moved to the third state in the second direction. In this embodiment, the gripping finger positioning assemblies 23 may be driven by the gripping fingers 21 to rotate in the second direction. In other embodiments, the drive unit may drive the fourth links 231 of the gripping finger positioning assemblies 23 to rotate in the second direction, thereby driving the entire parallelogram to rotate in the second direction. When the gripping device 100 grips the target object, the drive unit 30 drives the first links 221 to rotate in the first direction which in turn drives the gripping fingers 21 to move inward, such that the adhesion assemblies 24 contact the target object, thereby achieving the gripping operation by the adsorption and/or adhesion action of the adhesion assemblies 24.

In the above embodiments, the gripping device 100 provided by the present disclosure can perform four different gripping modes, which can be adapted to different scenarios.

Based on the above concept, as shown in FIG. 6, another aspect of the present disclosure further provides a robot 300. The robot 300 may include at least one connecting member 31 and at least one gripping device 32. The robot 300 may be configured to grip or capture a target object. The gripping device 32 may be any gripping device as described in the previous embodiments. It should be understood by those of ordinary skill in the art that the structure shown in FIG. 6 is only an exemplary embodiment of the robot 300. In other embodiments, the robot 300 may include more components or fewer components. For example, the robot may also include an input and output device, a network access device, a communication bus, a processor, a memory, an actuator, and sensors, etc. These additional components may implement a control system, such as switching instructions. For example, the robot 300 may also include a processor and a memory for storing instructions, and when executed by the processor, the instructions cause the processor to implement the control system. The memory may also store instructions that, when executed by the processor, cause the processor to activate or deactivate the gripping device 32 in order to grip or release the target object to be gripped.

The technical features in the above embodiments may be randomly combined. In order to make the description concise, not all possible combinations of the technical features in the above embodiments are described. However, all the combinations of the technical features should be considered as falling within the scope of the specification as long as there is no contradiction.

The above-mentioned embodiments only illustrate several embodiments of the present disclosure, and the descriptions thereof are relatively specific and detailed, but should not be construed as a limitation on the scope of the patent of the present disclosure. It should be noted that for those skilled in the art, without departing from the concept of the present disclosure, several modifications and improvements can be made, which all fall within the protection scope of the present disclosure. Therefore, the scope of protection of the present disclosure shall be subject to the appended claims.

What is claimed is:

1. A gripping device configured to grip a target object, the gripping device comprising:
a base; and
at least two gripper assemblies, each of the gripper assemblies comprising:
a gripping finger configured to grip the target object, the gripping finger having a first state and a second state, an angle of a gripping surface of each gripping finger being kept unchanged in the first state, and each of the gripping fingers being moved close to each other in a first direction in the second state in comparison with the first state; and
a first link assembly, one end of the first link assembly being rotatably connected to the base, and the other end of the first link assembly being rotatably connected to the gripping finger;
the gripping device having a first gripping mode, a second gripping mode and a third gripping mode, wherein
in the first gripping mode, the gripping fingers are in the first state, and the first link assemblies are configured to drive the gripping fingers to move inward and contact the target object;
in the second gripping mode, the gripping fingers are in the first state, and the first link assemblies are configured to drive the gripping fingers to move outward and contact the target object; and
in the third gripping mode, the first link assemblies are configured to drive the gripping fingers switch to the second state from the first state, and drive the gripping fingers to move inward and contact the target object in cooperation with the first link assemblies.

2. The gripping device according to claim 1, wherein each of the gripper assemblies further comprises an adhesion assembly, the adhesion assembly being arranged on an inner side of the corresponding gripping finger, and/or the adhesion assembly being arranged on an inner side of the corresponding first link assembly;
each gripping finger further has a third state in which the gripping fingers are moved away from each other in a second direction in comparison with the first state;
the gripping device further has a fourth gripping mode in which the gripping fingers are in the third state and the first link assemblies are configured to drive the gripping fingers to move inward to enable the adhesion assemblies to contact the target object.

3. The gripping device according to claim 2, wherein each of the gripper assemblies further comprises a gripping finger positioning assembly and an orientation control assembly, the orientation control assembly being connected to a first end of the gripping finger positioning assembly, and configured to control a posture of the corresponding gripping finger by controlling a posture of the gripping finger position assembly;
wherein, for each gripper assembly, in the first gripping mode and the second gripping mode, the orientation control assembly is configured to control the other end of the gripping finger positioning assembly to contact the gripping finger to maintain the gripping finger in the first state.

4. The gripping device according to claim 3, wherein each of the gripper assemblies further comprises a tension providing component configured to provide a tension force for the corresponding first link assembly, such that the corresponding gripping finger has a tendency to move towards the second direction under the tension force; and
for each gripper assembly, in the first gripping mode and the second gripping mode, the gripping finger positioning assembly is configured to provide a support force to the gripping finger to prevent the gripping finger from being moved towards the second direction, thereby maintaining the gripping finger in the first state.

5. The gripping device according to claim 4, wherein each gripping finger comprises a first portion and a second portion connected perpendicularly, each first link assembly comprises a plurality of links, the plurality of links cooperate with the first portion of the gripping finger to form a quadrilateral link structure, and the quadrilateral link structure is configured to rotate when driven by a drive device, thereby moving the gripping finger and adjusting the state of the gripping finger.

6. The gripping device according to claim 5, wherein each first link assembly comprises a first link, a second link, and a third link, wherein
a first end of the first link is rotatably connected to the base, a second end of the first link is rotatably connected to a first end of the second link, the tension providing component is connected between the first link and the second link to provide a torque force to the first link and the second link, such that the second link has a tendency to deflect with respect to the first link in the second direction and pulls the corresponding gripping finger, and the corresponding gripping finger has a tendency to move towards the second direction;
a second end of the second link is rotatably connected to one end of the first portion of the corresponding gripping finger, and the other end of the first portion of the corresponding gripping finger is rotatably connected to a first end of the third link, and a second end of the third link is rotatably connected to the base; and
in the third gripping mode, each gripping finger grips the target object in cooperation with the corresponding third link.

7. The gripping device according to claim 4, wherein each gripping finger positioning assembly comprises at least one link, and the at least one link forms a support structure that provides the support force to the corresponding gripping finger in the first gripping mode and the second gripping mode.

8. The gripping device according to claim 7, wherein each gripping finger positioning assembly comprises a fourth link, a fifth link, and a sixth link,
wherein the fourth link, the fifth link, the sixth link and the corresponding third link are rotatably connected in sequence to jointly constitute a parallelogram link assembly, and the fourth link is always parallel to the sixth link;
the parallelogram link assembly is configured to provide the support force in the first gripping mode and the second gripping mode by the sixth link contacting the first portion of the gripping finger in parallel.

9. The gripping device according to claim 8, wherein in the fourth gripping mode, the orientation control assembly is configured to control the fourth link to rotate in the second direction such that the gripping finger is moved to the third state in the second direction under the tension force provided by the tension providing component.

10. The gripping device according to claim 9, wherein each orientation control assembly comprises a cam in contact with the corresponding fourth link, wherein for each gripper assembly:
the cam is configured to, in a first position, maintain the fourth link and the sixth link in an initial state, such that the gripping finger is maintained in the first state under the tension force provided by the tension providing component and the support force provided by the sixth link; and
the cam is further configured to, in a second position, enable the fourth link and the sixth link to be deflected in the second direction, such that the gripping finger is moved towards the second direction under the tension force provided by the tension providing component, and the gripping finger is switched to the third state.

11. The gripping device according to claim 2, wherein the adhesion assembly is made of gecko adhesive material.

12. A robot, comprising a gripping device, the gripping device comprising:
a base; and
at least two gripper assemblies, each of the gripper assemblies comprising:
a gripping finger configured to grip the target object, the gripping finger having a first state and a second state, an angle of a gripping surface of each gripping finger being kept unchanged in the first state, and each of the gripping fingers being moved close to each other in a first direction in the second state in comparison with the first state; and
a first link assembly, one end of the first link assembly being rotatably connected to the base, and the other end of the first link assembly being rotatably connected to the gripping finger;
the gripping device having a first gripping mode, a second gripping mode and a third gripping mode, wherein
in the first gripping mode, the gripping fingers are in the first state, and the first link assemblies are configured to drive the gripping fingers to move inward and contact the target object;
in the second gripping mode, the gripping fingers are in the first state, and the first link assemblies are configured to drive the gripping fingers to move outward and contact the target object; and
in the third gripping mode, the first link assemblies are configured to drive the gripping fingers switch to the second state from the first state, and drive the gripping fingers to move inward and contact the target object in cooperation with the first link assemblies.

13. The robot according to claim 12, wherein each of the gripper assemblies further comprises an adhesion assembly, the adhesion assembly being arranged on an inner side of the corresponding gripping finger, and/or the adhesion assembly being arranged on an inner side of the corresponding first link assembly;
each gripping finger further has a third state in which the gripping fingers are moved away from each other in a second direction in comparison with the first state;
the gripping device further has a fourth gripping mode in which the gripping fingers are in the third state and the first link assemblies are configured to drive the gripping fingers to move inward to enable the adhesion assemblies to contact the target object.

14. The robot according to claim 13, wherein each of the gripper assemblies further comprises a gripping finger positioning assembly and an orientation control assembly, the orientation control assembly being connected to a first end of the gripping finger positioning assembly, and configured to control a posture of the corresponding gripping finger by controlling a posture of the gripping finger position assembly;
wherein, for each gripper assembly, in the first gripping mode and the second gripping mode, the orientation control assembly is configured to control the other end of the gripping finger positioning assembly to contact the gripping finger to maintain the gripping finger in the first state.

15. The robot according to claim 14, each of the gripper assemblies further comprises a tension providing component configured to provide a tension force for the corresponding first link assembly, such that the corresponding gripping finger has a tendency to move towards the second direction under the tension force; and
for each gripper assembly, in the first gripping mode and the second gripping mode, the gripping finger positioning assembly is configured to provide a support force to the gripping finger to prevent the gripping finger from being moved towards the second direction, thereby maintaining the gripping finger in the first state.

16. The robot according to claim 15, wherein each gripping finger comprises a first portion and a second portion connected perpendicularly, each first link assembly comprises a plurality of links, the plurality of links cooperate with the first portion of the gripping finger to form a quadrilateral link structure, and the quadrilateral link structure is configured to rotate when driven by a drive device, thereby moving the gripping finger and adjusting the state of the gripping finger.

17. The robot according to claim 16, wherein each first link assembly comprises a first link, a second link, and the third link, wherein
a first end of the first link is rotatably connected to the base, a second end of the first link is rotatably connected to a first end of the second link, the tension providing component is connected between the first link and the second link to provide a torque force to the first link and the second link, such that the second link has a tendency to move towards the second direction with respect to the first link and pulls the corresponding gripping finger, such that the corresponding gripping finger has a tendency to move towards the second direction;
a second end of the second link is rotatably connected to one end of the first portion of the corresponding gripping finger, and the other end of the first portion of the corresponding gripping finger is rotatably connected to a first end of the third link, and a second end of the third link is rotatably connected to the base; and
in the third gripping mode, each gripping finger grips the target object in cooperation with the corresponding third link.

18. The robot according to claim 15, wherein each gripping finger positioning assembly comprises at least one link, and the at least one link forms a support structure that provides the support force to the corresponding gripping finger in the first gripping mode and the second gripping mode.

19. The robot according to claim 18, wherein each gripping finger positioning assembly comprises a fourth link, a fifth link, and a sixth link,
wherein the fourth link, the fifth link, the sixth link and the corresponding third link are rotatably connected in sequence to jointly constitute a parallelogram link assembly, and the fourth link is always parallel to the sixth link;
the parallelogram link assembly is configured to provide the support force in the first gripping mode and the second gripping mode by the sixth link contacting the first portion of the gripping finger in parallel.

20. The robot according to claim 19, wherein in the fourth gripping mode, the orientation control assembly is configured to control the fourth link to rotate in the second direction such that the gripping finger is moved to the third state in the second direction under the tension force provided by the tension providing component.
